(19) United States
(12) Patent Application Publication
(10) Pub. No.: US 2020/0376678 A1
(43) Pub. Date: Dec. 3, 2020

(54) VISUAL SERVO SYSTEM

(71) Applicants: DENSO CORPORATION, Kariya-city (JP); TOHOKU UNIVERSITY, Sendai-shi (JP)

(72) Inventors: Takuto YANO, Kariya-city (JP); Masahiro NONO, Kariya-city (JP); Kazuhiro KOSUGE, Sendai-shi (JP); Shogo ARAI, Sendai-shi (JP); Yoshihiro MIYAMOTO, Sendai-shi (JP)

(21) Appl. No.: 16/886,821

(22) Filed: May 29, 2020

(30) Foreign Application Priority Data
May 31, 2019 (JP) 2019-103056

(51) Int. Cl. B25J 9/16; B25J 19/02; G05B 19/18; G06K 9/46; G06T 7/586

(52) U.S. Cl. CPC B25J 9/1697; B25J 19/023; G05B 2219/39391; G06K 9/4661; G06T 7/586; G05B 19/188

(57) ABSTRACT

A visual servo system includes a robot that handles an object, an irradiation device that irradiates light onto the object, and a camera that captures an image of the object and outputs a current image. The visual servo system reads, from a storage medium, a target image that is assumed to be captured by the camera when the object is in target position and attitude, and the light irradiated from the irradiation device is striking the object. The visual servo system calculates control input to be inputted to the robot based on a difference in luminance value between the current image and the target image, and inputs the control input to the robot. The light that is irradiated by the irradiation device is light that has a luminance distribution based on a reference image in winch a luminance value changes along a predetermined direction.

### CROSS-REFERENCE TO RELATED APPLICATIONS

This application is based on and claims the benefit of priority from Japanese Patent Application No. 2019-103056, filed May 31, 2019. The entire disclosure of the above application is incorporated herein by reference.

### BACKGROUND

### Technical Field

The present disclosure relates to a visual servo system.

### Related Art

Visual servoing is known as a technology for controlling a robot that handles a handled object. In visual servoing, to enable the robot to position the handled object at a target position and attitude, an image of the object that is being handled is captured by a camera. The image that is acquired as a result is a current image. The camera also captures, in advance, an image of a scene in which the robot is gripping the object in the target position and attitude. The image that is acquired as a result is a target image. In visual servoing, control input that is inputted to the robot is calculated from the target image and the current image.

### SUMMARY

An aspect of the present disclosure provides a visual servo system for moving an object. The visual servo system includes a robot that handles an object, an irradiation device that irradiates light onto the object, and a camera that captures an image of the object and outputs a current image. The visual servo system reads, from a storage medium, a target image that is assumed to captured by the camera when the object is in the target position and attitude, and the light irradiated from the irradiation device is striking the object. The visual servo system calculates control input to be inputted to the robot based on a difference in luminance value between the current image and the target image, and inputs the control input to the robot. The light that is irradiated by the irradiation device is light that has a luminance distribution based on a reference image in which a luminance value changes along a predetermined direction.

### BRIEF DESCRIPTION OF THE DRAWINGS

In the accompanying drawings:

FIG. 1 is a schematic configuration diagram of a visual servo system according to an embodiment;

FIG. 2 is a diagram of a portion of a reference image;

FIG. 3 is a diagram of a pattern appearing on an object due to irradiation;

FIG. 4 is an operation block diagram of the visual servo system;

FIG. 5 is a list of mathematical expressions:

FIG. 6 is a diagram of positional relationships among a projector, a camera, and an object;

FIG. 7 is a list of mathematical expressions;

FIG. 8 is a table of evaluation results regarding bleeding when N and M are set to various values;

FIG. 9 is experiment results showing positioning accuracy and convergence speed according to the present embodiment;

FIG. 10 is experiment results showing positioning accuracy and convergence speed when irradiation by the projector is not performed;

FIG. 11 is an image showing an experiment environment; and

FIG. 12 is a diagram of three-dimensional positioning error.

### DESCRIPTION OF THE EMBODIMENTS

In visual servoing, an image-based method is known as a method for calculating a control input. In the image-based method, the control input is determined based on a deviation of a feature quantity of the current image relative to a feature quantity of the target image (refer to K. Hashimoto, “Visual Servo-V: Image-based Visual Servo”, Transactions of the Institute of Systems. Control and Information Engineers, Vol. 54, No. 5, p. 206-213, 2010).

However, in visual servoing in which the image-based method is used, the deviation of the feature quantity of the current image relative to the feature quantity of the target image decreases near the target position. An amount of time that is required for positioning increases.

It is thus desired to increase, from that in the past, a deviation of a feature quantity of a current image relative to a feature quantity of a target image in a vicinity of a target position, in visual servoing in which an image-based method is used.

An exemplary embodiment provides a visual servo system for moving an object. The visual servo system includes a robot, an irradiation device, a camera, a reading unit, and an input unit. The robot handles the object. The irradiation device irradiates light onto the object that is handled by the robot and is fixed at a position that differs from a position of the robot. The camera captures an image of the object in a state in which the light irradiated by the irradiation device is striking the object, and outputs a current image. The camera is fixed at a position that differs from the position of the robot. The reading unit reads, from a storage medium, a target image that is assumed to be captured by the camera when the object is in target position and attitude and the light irradiated from the irradiation device is striking the object. The input unit calculates a control input to be inputted to the robot based on a difference in luminance value between the current image and the target image, and inputs the control input to the robot. The light that is irradiated by the irradiation device is light that has a luminance distribution that is based on a reference image in which the luminance value changes along a predetermined direction.

As a result of the luminance values of the target image and the current image being used as the feature quantities, and light that has a luminance distribution that is based on a reference image in which the luminance value changes along the predetermined direction being used, deviation of the feature quantity of the current image relative to the target image can be increased from that in the past in the vicinity of a target position. A reason for this is that, when the luminance values of the target image and the current image are used as the feature quantity as a square of a first-order differential of the luminance value related to a pixel in the reference image increases, the deviation of the feature quantity of the current image relative to the target image increases.

An embodiment of the present disclosure will hereinafter be described.

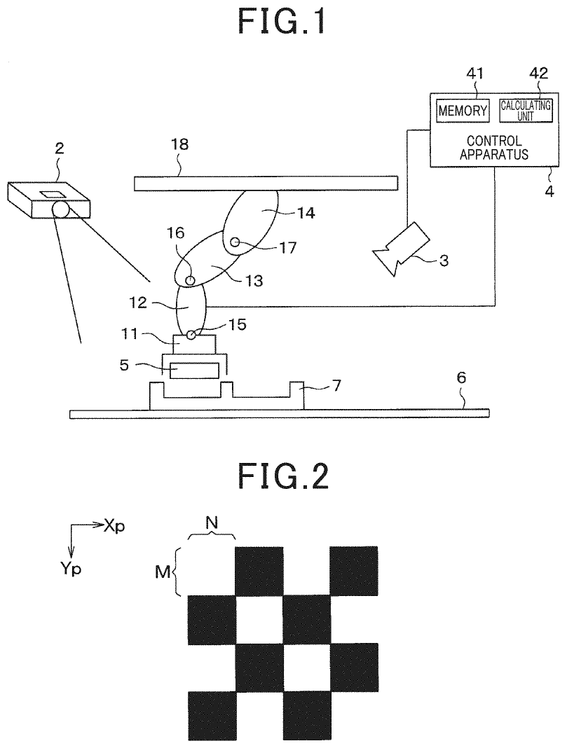

As shown in FIG. 1, a visual servo system according to the present embodiment includes a robot 1, a projector 2, a camera 3, and a control apparatus 4. The projector 2 corresponds to an irradiation device.

The robot 1 is an industrial robot arm that is arranged in a production plant or the like. The robot 1 grips an object 5, such as a component. The robot 1 then moves the object 5 to actualize target position and attitude (orientation) that are prescribed in advance for the object 5. For example, the target position is a predetermined position in a kitting tray 7 that is placed on a floor 6. To actualize such functions, the robot 1 includes a hand 11, a plurality of links 12, 13, and 14, and a plurality of joints 15, 16, and 17. The hand 11 grips the component.

The hand 11 is a member that includes a gripping mechanism (not shown) that is capable of gripping and releasing the object 5. One end of the link 12 is connected to the hand 11 through the joint 15. One end of the link 13 is connected to the other end of the link 12 through the joint 16. One end of the link 14 is connected to the other end of the link 13 through the joint 17. The other end of the link 14 is connected to a fixture 18.

The joint 15 is configured by a servomotor or the like. The joint 15 changes the position and the attitude of the hand 11 relative to the link 12. The joint 16 is configured by a servomotor or the like. The joint 16 changes the position and the attitude of the link 12 relative to the link 13. The joint 17 is configured by a servomotor or the like. The joint 17 changes the position and the attitude of the link 13 relative to the link 14.

The robot 1 is not limited to a robot arm such as that described above. As long as the robot 1 includes a hand, a plurality of links, and one or more joints that change relative positions and relative attitudes of the hand and the links, any type of robot arm can be used. For example, the robot 1 may be a five-axis-control robot arm.

The projector 2 is an apparatus that irradiates light onto the object 5 that is present in the vicinity of the target position as a result of the robot 1 gripping and handling the object 5. The projector 2 is fixed at a position that differs from a position of the robot 1. In addition, an optical center and an optical axis of the projector 2 are fixed. The light that is irradiated by the projector 2 is light that has a luminance distribution that is based on a reference image that is stored in the projector 2 in advance. The reference image is also referred to as a projected image. Details of the reference image will be described hereafter.

The camera 3 captures an image of the object 5 and a periphery thereof, the object 5 being present in the vicinity of the target position as a result of being gripped and handled by the robot 1. The camera 3 outputs, to the control apparatus 4, the current image that is the captured image that is obtained as a result. The camera 3 is fixed at a position that differs from the position of the robot 1. In addition, an optical center and an optical axis of the camera 3 are fixed.

The control apparatus 4 is an apparatus that controls the robot 1 such that the object 5 actualizes the target position and attitude based on the current image acquired from the camera 3. The control apparatus 4 is an apparatus that includes a memory 41, a calculating unit (e.g., a calculator or a computer) 42, and the like. For example, the control apparatus 4 may be a microcomputer. The memory 41 is a non-transitory computer-readable storage medium that includes a random access memory (RAM), a read-only memory (ROM), and a flash memory. The calculating unit 42 performs a process described hereafter by reading a program from the memory 41 and performing a process based on the program.

Here, the reference image will be described. As shown in FIG. 2, the reference image is an image in which a luminance value changes along both a predetermined direction (corresponding to a first direction) Xp and the other direction (corresponding to a second direction) Yp. The other direction Yp intersects with and is orthogonal to the predetermined direction Xp. In addition, the reference image is an image in which the luminance value changes such that a high-luminance-value portion and a low-luminance-value portion alternate along both the predetermined direction Xp and the other direction Yp. In FIG. 2, a white-colored portion indicates a pixel that has a high luminance value (corresponding to a first luminance value). A black-colored portion indicates a pixel that has a low luminance value (corresponding to a second luminance value).

More specifically, the luminance value changes such that the high luminance value and the low luminance value alternate every N pixels along the direction Xp. In addition, the luminance value changes such that the high luminance value and the low luminance value alternate every M pixels along the direction Yp. Here, N and M may be set to 1. Alternatively, N and M may be set to 2 or greater. Moreover, N and M may be set to a same value or differing values. For example, N=M=45.

Here, the high luminance value is a value that is higher than the low luminance value. For example, the high luminance value may be a maximum luminance value (such as 255) that can be set. The low luminance value may be a minimum luminance value (that is, zero) that can be set. Alternatively, the high luminance value and the low luminance value may be other than the maximum luminance value and the minimum luminance value. An absolute value of a difference between the high luminance value and the low luminance value may be equal to or greater than ½, or equal to or greater than ⅓, of an absolute value of a difference between the maximum luminance value and the minimum luminance value.

In addition, the high luminance value may be the same value for all pixels in the reference image. Alternatively, the high luminance value may not be the same value for all pixels in the reference image. In a similar manner, the low luminance value may be the same value for all pixels in the reference image. Alternatively, the low luminance value may not be the same value for all pixels in the reference image.

Hereafter, operations of the visual servo system will be described. First, the robot 1 moves the object 5 to the vicinity of the target position, in a state in which the robot 1 is gripping the object 5. As a result, the object 5 enters an irradiation range of the projector 2 and an imaging range of the camera 3.

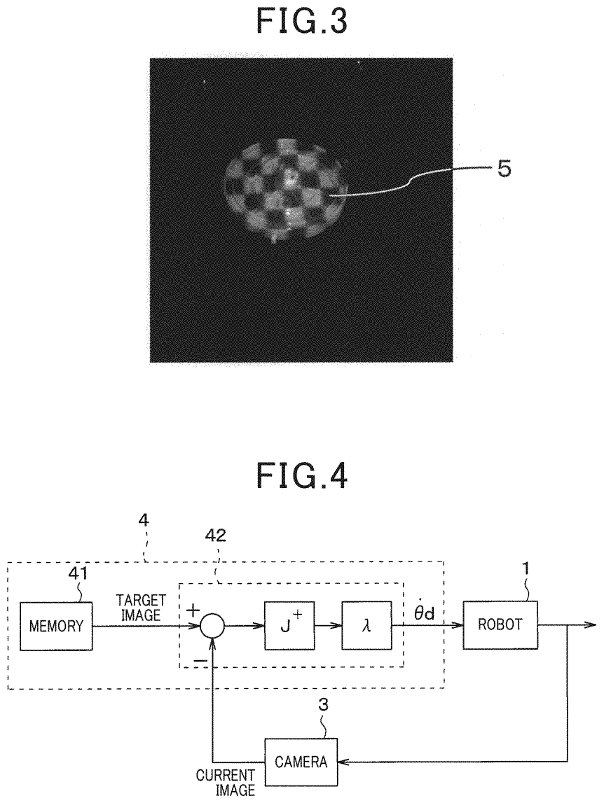

Therefore, the light that is irradiated by the projector 2 at the luminance distribution that is based on the reference image strikes the object 5. The light that strikes a surface of the object 5 is reflected and incident on the camera 3. At this time, as shown in FIG. 3, a pattern that corresponds to the reference image appears on the surface of the object 5 in the current image that is captured and outputted by the camera 3. However, the pattern that appears on the surface of the object 5 is distorted relative to the reference image based on shape and tilt of the surface of the object 5.

As shown in FIG. 4, the control apparatus 4 acquires the current image that is outputted from the camera 3 in this manner. Upon acquiring the current image from the camera 3, the calculating unit 42 of the control apparatus 4 calculates a difference between the luminance value of the current image and the luminance value of the target image that is read from the memory 41. Here, the difference in luminance value refers to a difference between corresponding pixels in the two images.

Here, the target image that is recorded in the memory 41 will be described.

The target image is an image that the camera 3 is assumed to capture if the object 5 is in the target position and attitude, and struck by the light irradiated from the projector 2. The target image can be acquired by the robot 1 being made to grip the object 5, or an object that is configured by a same material and has a same shape and a same surface shape as the object 5, and place the object 5 or the object in the target position and attitude, the projector 2 being made to perform irradiation, and the camera 3 being made to capture an image, in advance. The target image that is acquired in this manner is recorded in the memory 41 (such as a non-volatile memory) of the control apparatus 4 in advance. Subsequently, the calculating unit 42 reads the target image as described above, during control of the robot 1. The calculating unit 42 functions as a reading unit by reading the target image from the memory 41.

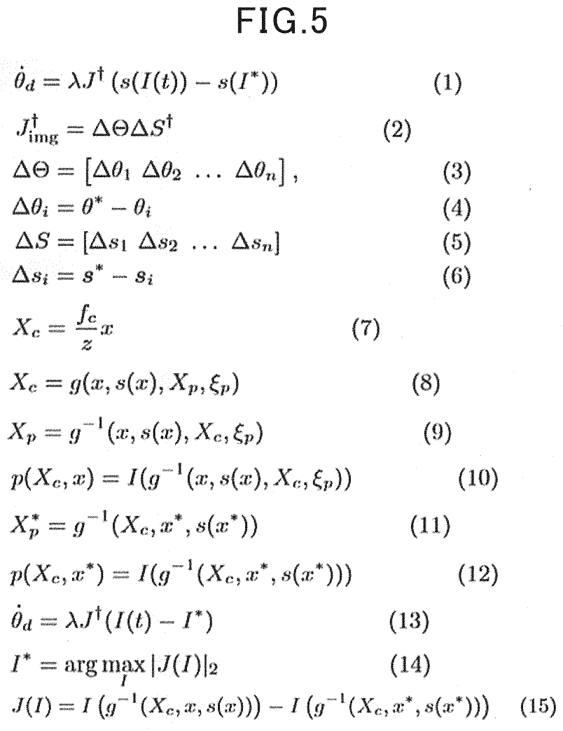

In addition, as shown in FIG. 2, the calculating unit 42 applies a pseudo-inverse matrix J⁺ of the image Jacobian to the calculated difference in luminance value between the current image and the target image, and further multiplies the calculated difference in luminance value by gain λ. The image Jacobian is determined in advance in a manner similar to that in the past. However, at this time, the feature quantity of the image is the luminance value itself of each pixel in the image. A value that is obtained as through application of the pseudo-inverse matrix J+ of the image Jacobian and multiplication by gain λ is a control input that is inputted to the robot 1. The control input is a time derivative of an angle θd, or in other words, angular velocity of each of the joints 15, 16, and 17. In this manner, a control law of the visual servo system according to the present embodiment is as shown in expression (13) in FIG. 5. Here, I(t) denotes the current image and I* denotes the target image. The calculating unit 42 functions as an input unit by inputting the control input to the robot 1.

The robot 1 operates the joints 15, 16, and 17 based on the time derivatives of the angle θd that are inputted as described above. As a result, the robot 1 displaces the object 5 so as to approach the target position and attitude. When the position of the object 5 sufficiently approaches the target position and attitude as a result of such control of the robot 1 based on the current image being repeated over time, positioning is completed.

Here, technical significance according to the present embodiment will be described. First, conventional visual servoing in which an image-based method is used will be described.

An object of the conventional visual servoing method is to position an object that is gripped by a robot in the target position and attitude. A single camera that is set in an environment captures an image of the object that is being handled. In addition, the camera captures, in advance, an image of a scene in which the robot is gripping the object in the target position and attitude. The captured image is set as the target image. In visual servoing, the control input that is inputted to the robot is calculated based on the target image and an image that is captured at a current time and fed back. Methods for calculating the control input are largely divided into two types, a position-based method and an image-based method. Here, the image-based method will be described.

In the image-based method, the robot is controlled through feedback of a feature quantity that is directly calculated from an image. Here, the feature quantity is a multidimensional vector that indicates a feature that can be calculated without use of robot-camera calibration or camera models, such as an edge or coordinates of a center of gravity of a target object. A most basic control law is provided by expression (1) in FIG. 5.

Here, θ∈Rⁿ denotes a joint angular velocity command value of the robot, λ denotes gain, J⁺ denotes the pseudo-inverse matrix of the image Jacobian, and s(I) denotes mapping from a current image I to a feature quantity. The image Jacobian is mapping from a deviation between the target image and the current image to a joint angular velocity space of the robot. Strictly speaking, the image Jacobian is dependent on a joint angle of the robot. However, in the vicinity of the target position and attitude, it is thought that the image Jacobian can be considered fixed and a time-invariant Jacobian is often applied. In this case, the image Jacobian can be calculated by expression (2) in FIG. 5. Here, expressions (3), (4), (5), and (6) in FIG. 5 are established.

In expressions (3) to (6), an image feature quantity and a joint angle when the handled object is in the target position and attitude are respectively denoted by s* and θ*. An image feature quantity and a joint angle when the handled object is slightly shifted from the target position and attitude are respectively denoted by sᵢ and θᵢ. That is, when the image Jacobian is calculated by expression (2), images in which the handled object is slightly shifted from the target position and attitude n times are required to be acquired.

The following issues have been identified regarding the image-based method described above:

1. positioning errors tend to occur when the object to be handled lacks texture, and

2. image deviation typically decreases near the target position, and time required for positioning increases.

Returning to the description according to the present embodiment, the projector 2 is used to address the above-described issues, according to the present embodiment.

As shown in FIG. 1, in the visual servoing method according to the present embodiment, pattern light is irradiated onto the handled object using the projector 2. The camera 3 captures an image of the reflected light reflected by the handled object. Image-based visual servoing is then performed. The following two effects can be expected as a result of the pattern light being projected:

1. positioning errors regarding a handled object that lacks texture is reduced, and

2. image deviation near the target position increases, and time required for positioning is shortened.

The pattern light is also referred to as structured light. A significant factor in determining accuracy of positioning in visual servoing is an irradiation pattern based on the reference image. Hereafter, technical significance of the irradiation pattern will be described.

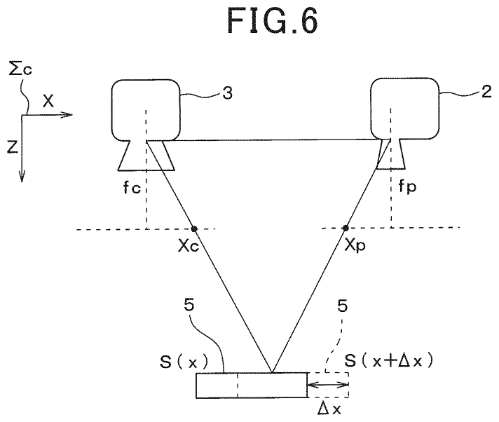

A two-dimensional space shown in FIG. 6 is considered. The object 5, the robot 1, the projector 2, and the camera 3 are set in this space. A coordinate system Σ_{c} is fixed. The camera 3 is set such that the optical axis thereof coincides with a Z-axis direction. That is, the coordinate system Σ_{c} is a camera coordinate system. Imaging by the camera 3 is presumed to be based on a pin-hole camera model. That is, a point that is present in position (x,z) is projected onto X_{c} in expression (7) on a camera image plane, by perspective projection transformation.

Here, fc denotes a focal distance of the camera 3. The projector 2 is set in position (xₚ,zₚ) such that the optical axis thereof forms an angle θ, relative to the z-axis. A position and attitude of the projector 2 that is set in this manner is written as ξₚ: =[xₚ,yₚ,θₚ]^{T}. In addition, projection by the projector 2 is also presumed to be based on the pin-hole camera model.

Here, the position and attitude of the handled object is written as x, and a function that expresses a surface shape of the handled object in two-dimensional space is expressed by s(x). The target position and attitude of the object 5 is x*. Here, a presumption is made that, while the robot 1 is handling the object 5, the camera 3 captures an image of at least a portion of the object 5 and the projector 2 irradiates the pattern light onto the captured area Under these conditions, light irradiated from Xₚ on a reference image plane being reflected on a handled-object surface (x,s(x)) and reaching the camera image plane X_{c} can be considered. Here, this relationship is expressed as in expression (8) in FIG. 5, through use of mapping g from the reference image plane onto a camera projector plane.

Next, the pattern light that is irradiated from the projector 2 will be considered. Irradiation is performed from the reference image plane Xₚ at a luminance of I(Xₚ). That is, I(Xₚ) is a function that expresses the reference image.

Here, luminance of a light ray that is incident on the camera image plane X_{c} is considered. This light ray is light that is irradiated from a projector pixel Xₚ that is indicated in expression (9) in FIG. 5. Here, g⁻¹ is an inverse function of g. The luminance of the light ray that is irradiated from this projector pixel Xₚ is I(Xₚ). Therefore, when expression (9) is used, intensity p(X_{c},x) of the light that is incident on e X_{c} can be written as in expression (10) in FIG. 5. Here, a presumption is made that the luminance of irradiation from the projector 2 is equal to the luminance that is observed by the camera 3.

Here, when the object 5 moves to the target position ξₚ, the same light ray that is incident on the camera image plane X_{c} is irradiated from a projector pixel X*, that is indicated in expression (11) in FIG. 5. Therefore, luminance p(X_{c},x*) that is observed at the camera pixel X_{c} is as in expression (12) in FIG. 5.

Here, a control side of the visual servo system according to the present embodiment is provided in expression (13) in FIG. 5. Expression (13) is obtained by feature quantity sin expression (1) being changed to image. The image I is matrix data in which a luminance value is stored for each pixel. Therefore, calculation to extract the feature quantity from the image is not required. Compared to the conventional image-based method expressed in expression (1), high-speed calculation can be performed.

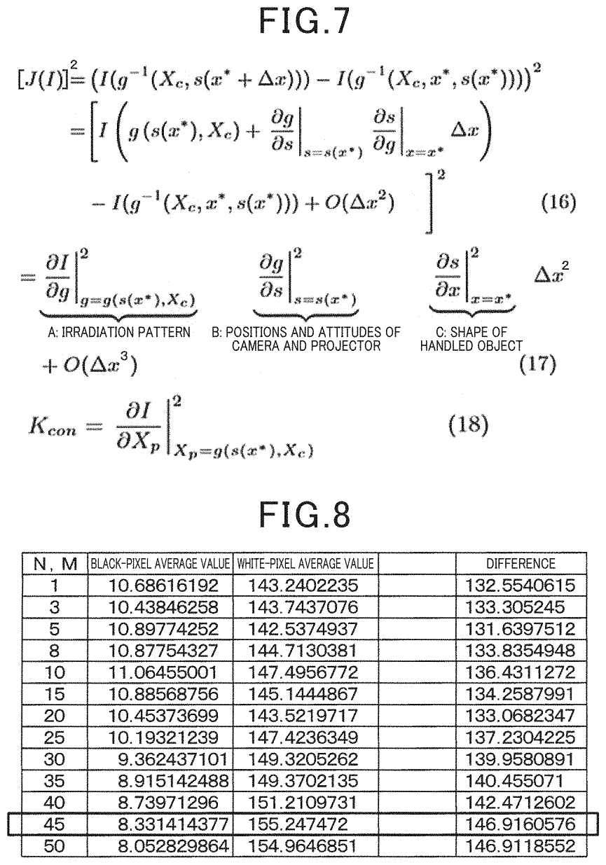

To reduce positioning errors and shorten the amount of time required for positioning, an irradiation pattern I* that maximizes the image deviation in expression (13) in the vicinity of the target position is determined based on expression (14). Here, expression (15) is established, and |ξ|₂ expresses a Euclidean norm of vector ξ. Taking into consideration the position and attitude x being in the vicinity of the target position and attitude x*, when Taylor expansion is applied to expression (15) in the vicinity of x*, expression (16) in FIG. 7 is obtained. Here, O(Δx³) expresses a remainder term of third and subsequent orders of Δx:=x−x*.

In expression (17), B and C are respectively dependent on the shape of the object 5, and the positions and attitudes of the camera 3 and the projector 2. Term A is a term that is dependent on the irradiation pattern. Therefore, I that maximizes term A is determined. Here, X^{p}=g(s(x*).Xc). Therefore, term A can be written as in expression (18). This expression indicates magnitude when first-order differentiation of irradiation luminance by pixel coordinates on the reference image plane is determined. Taking into consideration the reference image being configured by pixels of a certain size, for example, the irradiation pattern that maximizes expression (17) is a grid pattern. From such a perspective, according to the present embodiment, an image of a grid pattern described above is used as the reference image.

However, when an image of the pattern on the surface of the object 5 formed by the light irradiated by the projector 2 based on the reference image is captured by the differing camera 3, bleeding may occur. Bleeding tends to occur as the above-described values of N and M of the reference image decrease.

FIG. 8 shows experiment results regarding the degree of bleeding in the current image that is captured by the camera 3 when N and M are set to various values. In FIG. 8, a black-pixel average value refers to an average value, in a single current image, of luminance values of black pixels in the overall current image when pixels of which the luminance value is equal to or less than 126 are classified as black pixels. In a similar manner, a white-pixel average value refers to an average value, in a single current image, of luminance values of white pixels in the overall current image when pixels of which the luminance value is equal to or greater than 127 are classified as white pixels. In addition, difference refers to a difference between the white-pixel average value and the black-pixel average value. Bleeding decreases as the difference increases. Here, a range of values from which pixels are taken in the experiment is equal to or greater than the minimum luminance value 0 and equal to or less than the maximum luminance value 255. In the experiment results in FIG. 8, bleeding is minimum when N=M=45. In addition, the white-pixel average value is high. Furthermore, bleeding is decreases when N and M are equal to or greater than 2, compared to when N and M are 1.

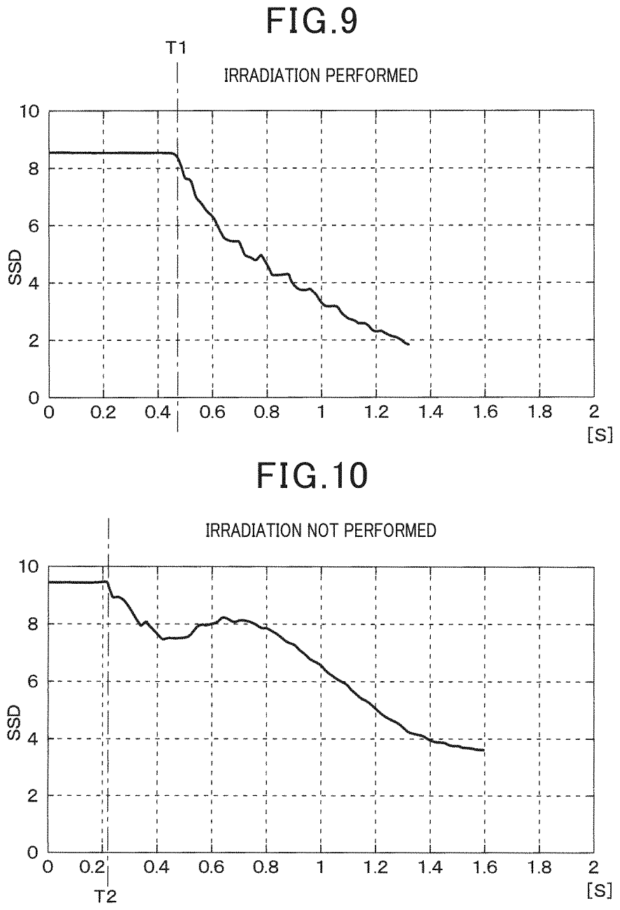

FIG. 9 shows experiment results indicating accuracy of positioning and convergence speed according to the present embodiment. In addition, FIG. 10 shows experiment results when irradiation by the projector 2 is not performed under identical conditions as those of the experiment in FIG. 9, as a comparison example. Here, regarding an absolute value of gain k, the absolute value is greater in the experiment in FIG. 9 than in the experiment in FIG. 10. In FIG. 9 and FIG. 10, a horizontal axis indicates time. A vertical axis indicates a sum of squared difference (SSD) of the image deviation between the target image and the current image.

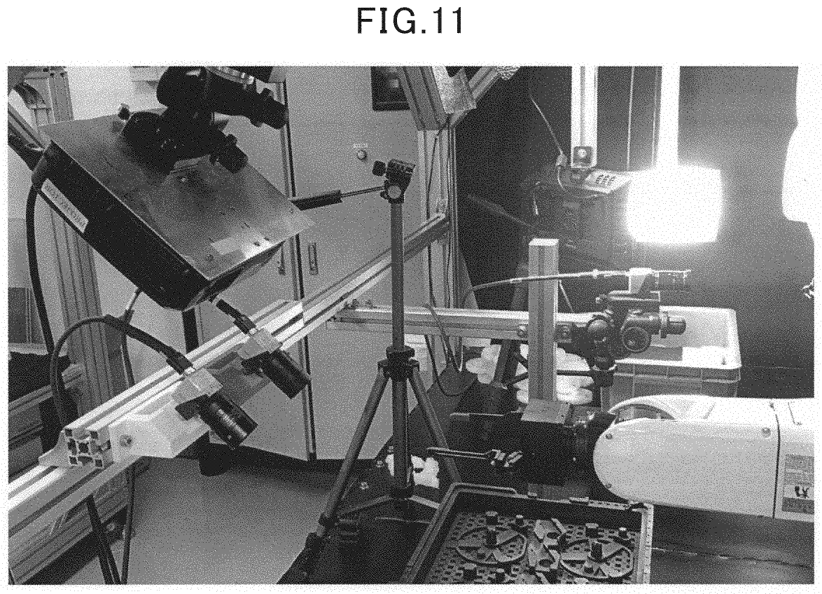

FIG. 11 shows an experiment environment of the experiments in FIG. 9 and FIG. 10. The camera 3 is a high-speed camera IDP-Express R2000 manufactured by Photron Limited. The projector 2 is an EB-W420 manufactured by Seiko Epson Corporation. The resolution of the camera is 512×512 pixels. The resolution of the projector 2 is 1280×800 pixels. The frame rate of the camera 3 is 50 fps.

As shown in FIG. 9 and FIG. 10, it is clear that convergence, that is, completion of positioning, is faster when irradiation by the projector 2 is performed, compared to when irradiation is not performed. A reason for this is that, in the method according to the present embodiment, the deviation of the feature quantity of the current image relative to the target image increases, and therefore, the absolute value of gain k can be increased. Here, time T1 in FIG. 9 and time T2 in FIG. 10 indicate times at which the visual servoing process shown in FIG. 4 is started.

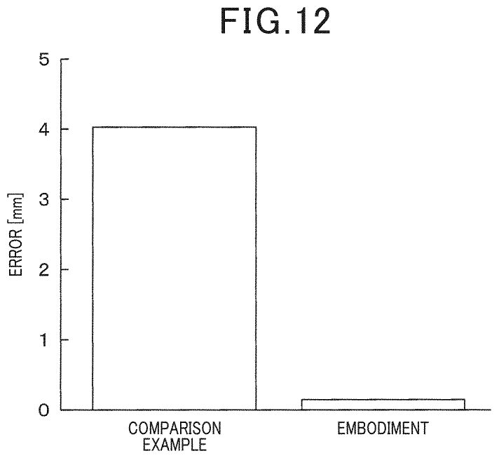

In addition, FIG. 12 shows three-dimensional positioning errors measured by a laser sensor at an end time, in visual servoing of the comparison example and that according to the present embodiment. As shown in the graph, positioning errors can be significantly reduced by the method according to the present embodiment.

As described above, according to the present embodiment, the light that is irradiated by the projector 2 is light that has a luminance distribution that is based on a reference image in which the luminance value changes along the predetermined direction Xp.

As a result of the luminance values of the target image and the current image being used as the feature quantities, and the light that has a luminance distribution based on the reference image in which the luminance value changes along the predetermined direction Xp being used as described above, the deviation of the feature quantity of the current image relative to that of the target image can be increased from that in the past in the vicinity of the target position. A reason for this is that, as described above, when the luminance values of the target image and the current image are used as the feature quantities, as the square of the first-order differential of the luminance value related to the pixel in the reference image increases, the deviation of the feature quantity of the current image relative to the target image increases.

In addition, in the reference image, the luminance value changes so as to alternate between the large luminance value and the small luminance value along the predetermined direction Xp in the reference image. As a result, a total of the squares of the first-order differential of the luminance value related to the pixels in the overall reference image can be increased, compared to when the luminance values of the pixels monotonically decrease or increase. Moreover, the deviation of the feature quantity of the current image relative to the target image can be increased.

In addition, in the reference image, the luminance value changes so as to alternate between the large luminance value and the small luminance value along the predetermined direction Xp in the reference image, at every plurality of pixels. As a result, bleeding of pixels in the image that is captured by the camera 3 can be reduced. Furthermore, the deviation of the feature quantity of the current image relative to the target image can be increased.

Moreover, the luminance value also changes along the other direction Yp that intersects the predetermined direction Xp. As a result, a more flexible response can betaken regarding misalignment relative to the target position and attitude. The deviation of the feature quantity of the current image relative to the target image can be increased.

In addition, the reference image is an image of a grid pattern. In this manner, as a result of the reference image being an image of a grid pattern, the luminance value changes such that the large luminance value and the small luminance value alternate along substantially all directions in the reference image.

### Other Embodiments

Here, the present disclosure is not limited to the above-described embodiment. Modifications can be made as appropriate. In addition, an element that configures an embodiment according to the above-described embodiments is not necessarily a requisite unless particularly specified as being a requisite, clearly considered a requisite in principle, or the like.

Furthermore, in cases in which a numeric value, such as quantity, numeric value, amount, or range, of a constituent element of an embodiment is stated according to the above-described embodiments, the numeric value is not limited to the specific number unless particularly specified as being a requisite, clearly limited to the specific number in principle, or the like. In particular, when a plurality of values are given as examples for a certain quantity, a value between the plurality of values can also be used, unless stated otherwise or clearly fundamentally not applicable.

Furthermore, according to the above-described embodiment, when a shape, a direction, a positional relationship, or the like of a constituent element or the like is mentioned, excluding cases in which the shape, the direction, the positional relationship, or the like is clearly described as particularly being a requisite, is clearly limited to a specific shape, direction, positional relationship, or the like in principle, or the like, the present disclosure is not limited to the shape, direction, positional relationship, or the like.

Moreover, according to the above-described embodiment, in cases in which external environment information (such as humidity outside a vehicle) of a vehicle is described as being acquired from a sensor, the sensor can be omitted and the external environment information can be received from an external server to the vehicle or from a cloud. Alternatively, the sensor can be omitted, and related information that is related to the external environment information can be acquired from the external server of the vehicle or a cloud.

The external environment information can thereby be estimated from the acquired related information. In addition, the present disclosure also allows variation examples and variation examples within a scope of equivalency, such as those below, according to the above-described embodiment. Here, the variation examples below can be independently selectively applied and not applied to the above-described embodiment. That is, arbitrary combinations of the following variation examples excluding clearly contradictory combinations can be applied to the above-described embodiment.

According to the above-described embodiments, the directions Xp and Yp in which the luminance values of the reference image change are orthogonal. However, the directions are not necessarily required to be orthogonal. When the directions are orthogonal, as according to the above-described embodiment, the reference image is the image of the rectangular grid pattern. However, when the directions are not orthogonal, the reference image is an image of a parallelogrammatic grid pattern. In addition, the reference image may be an image of a dotted pattern, rather than the grid pattern.

In addition, the reference image may be such that the luminance value changes only along the direction Xp. In this case, the reference image is an image of a stripe pattern.

In addition, the reference image according to the above-described embodiment is such that the luminance value changes such that the high luminance value and the low luminance value alternate along the direction Xp. However, the reference image is not necessarily required to be configured in this manner. For example, in the reference image, the luminance value may monotonically increase or monotonically decrease along the direction Xp.

According to the above-described embodiment, the projector 2 is given as an example of the irradiation device. However, an apparatus other than the projector 2 may be used as the irradiation device. For example, a visible light laser irradiation device may be used. In this case as well, the visible light laser irradiation device irradiates light that has a luminance distribution that is based on the reference image.

The control apparatus 4 and the method thereof described in the present disclosure may be actualized by a dedicated computer that is provided so as to be configured by a processor and a memory, the processor being programmed to provide one or a plurality of functions that are realized by a computer program. Alternatively, the control apparatus 4 and the method thereof described in the present disclosure may be actualized by a dedicated computer that is provided by a processor being configured by a single dedicated hardware logic circuit or more.

Still alternatively, the control apparatus 4 and the method thereof described in the present disclosure may be actualized by a single dedicated computer or more, the dedicated computer being configured by a combination of a processor that is programmed to provide one or a plurality of functions, a memory, and a processor that is configured by a single hardware logic circuit or more. In addition, the computer program may be stored in a non-transitory computer-readable storage medium that can be read by a computer as instructions performed by the computer.

What is claimed is:

1. A visual servo system for moving an object, the visual servo system comprising:
a robot that handles the object;
an irradiation device that irradiates light onto the object that is handled by the robot and is fixed at a position that differs from a position of the robot;
a camera that captures an image of the object in a state in which the light irradiated by the irradiation device is striking the object, and outputs a current image, the camera being fixed at a position that differs from the position of the robot;
a reading unit that reads, from a storage medium, a target image that is assumed to be captured by the camera when the object is in target position and attitude and the light irradiated from the irradiation device is striking the object; and
an input unit that calculates a control input to be inputted to the robot based on a difference in luminance value between the current image and the target image, and inputs the control input to the robot, wherein
the light that is irradiated by the irradiation device is light that has a luminance distribution that is based on a reference image in which the luminance value changes along a predetermined direction.

2. The visual servo system according to claim 1, wherein:
the luminance value includes a first luminance value and a second luminance value that is smaller than a first luminance value, and
in the reference image, the luminance value changes such that the first luminance value and the second luminance value alternate along the predetermined direction.

3. The visual servo system according to claim 2, wherein:
in the reference image, the luminance value changes such that the first luminance value and the second luminance value alternate along the predetermined direction at every plurality of pixels.

4. The visual servo system according to claim 1, wherein:
the predetermined direction is a first direction;
a direction that intersects the first direction is a second direction; and
in the reference image, the luminance value also changes along the second direction.

5. The visual servo system according to claim 2, wherein:
the predetermined direction is a first direction;
a direction that intersects the first direction is a second direction; and
in the reference image, the luminance value also changes along the second direction.

6. The visual servo system according to claim 3, wherein:
the predetermined direction is a first direction;
a direction that intersects the first direction is a second direction; and
in the reference image, the luminance value also changes along the second direction.

7. The visual servo system according to claim 4, wherein:
the luminance value includes a first luminance value and a second luminance value that is smaller than a first luminance value;
the second direction is orthogonal to the first direction;
in the reference image, the luminance value changes such that the first luminance value and the second luminance value alternate along the second direction; and
the reference image is an image of a grid pattern.

8. The visual servo system according to claim 5, wherein:
the second direction is orthogonal to the first direction;
in the reference image, the luminance value changes such that the first luminance value and the second luminance value alternate along the second direction; and
the reference image is an image of a grid pattern.

9. The visual servo system according to claim 6, wherein:
the second direction is orthogonal to the first direction;
in the reference image, the luminance value changes such that the first luminance value and the second luminance value alternate along the second direction; and
the reference image is an image of a grid pattern.
